(19) United States
(12) Patent Application Publication
(10) Pub. No.: US 2016/0231727 A1
(43) Pub. Date: Aug. 11, 2016

(54) SETUP CHANGE WORK INSTRUCTION METHOD

(71) Applicant: PANASONIC INTELLECTUAL PROPERTY MANAGEMENT CO., LTD., Osaka (JP)

(72) Inventor: Hiroki Sagara, Yamanashi (JP)

(21) Appl. No.: 14/881,917

(22) Filed: Oct. 13, 2015

(30) Foreign Application Priority Data
Feb. 6, 2015 (JP) 2015-022052

(51) Int. Cl. G05B 19/402; G05B 15/02

(52) U.S. Cl. CPC G05B 19/402; G05B 15/02; G05B 2219/49001; G05B 2219/36262

(57) ABSTRACT

Information about allocation states of parts feeders in a component feeding portion which is currently attached to a component mounting apparatus and information about allocation states of the parts feeders in a component feeding portion which has been detached from the component mounting apparatus are acquired. Work instruction information is derived. The work instruction information defines required setup change work so that allocation states of parts feeders in one of component feeding portions are changed over from allocation states to first allocation states corresponding to a first product type. The derived work instruction information is displayed on a display screen. The work instruction information includes a plurality of unit work information pieces. The plurality of unit work information pieces are displayed on the display screen so that the unit work information pieces are arranged in accordance with a work sequence order.

### CROSS REFERENCE TO RELATED APPLICATION

This application is based on Japanese Patent Application (No. 2015-022052) filed on Feb. 6, 2015, the contents of which are incorporated herein by reference.

### BACKGROUND

1. Technical Field

The present invention relates to a setup change work instruction method which is performed in order to change over a product type in a component mounting system.

2. Description of the Related Art

When different types of substrates are produced continuously in production activity using a component mounting apparatus, so-called setup change work is performed. That is, after substrates of one type have been produced, currently allocated feeders are replaced by feeders corresponding to components required for producing substrates of another type to be produced next. One form of such setup change work includes so-called offline setup work in which feeders required for producing substrates in and after the next production are allocated in carts which have been detached from the apparatus separately from the cart which is currently attached to the apparatus in production. In order to improve work efficiency in the setup change work performed so far, for example, a cart as a target of the setup change work is indicated to a worker and the worker is informed of components which should be replaced (e.g. see JP-A-2005-216965).

However, the related method disclosed in the example of JP-A-2005-216965 has the following problem in achieving improvement of the work efficiency in a real production site. That is, in the related art technique, instructions of individual works such as the indication of the cart as a target of the setup change work and the information about the components which should be replaced can be indeed given. However, there is no disclosure about a method for executing the setup change work efficiently and easily in a production site in which a plurality of works different in work contents or execution times are required to be executed continuously. Therefore, an effective remedial measure has been desired.

### SUMMARY

Therefore, an object of the invention is to provide a setup change work instruction method in which setup change work for changing over a product type can be executed efficiently and easily.

The setup change work instruction method according to the invention is a setup change work instruction method for giving an instruction to a worker to perform setup change work on a component mounting apparatus in order to change over a product type, the component mounting apparatus being comprising a component feeding portion which can be attached to or detached from the component mounting apparatus and in which a plurality of parts feeders can be allocated, the method including: acquiring information about allocation states of the parts feeders in the component feeding portion which is currently attached to the component mounting apparatus and information about allocation states of the parts feeders in a component feeding portion which has been detached from the component mounting apparatus; deriving work instruction information which defines required setup change work so that allocation states of parts feeders in one of the component feeding portions as a target of the setup change work are changed over from allocation states in which the setup change work has not been started yet to first allocation states corresponding to a first product type in order to be adapted to an event in which the product type is changed over to the first product type; and displaying the derived work instruction information on a display screen; wherein the work instruction information includes a plurality of unit work information pieces, and the plurality of unit work information pieces are displayed on the display screen in the displaying step so that the unit work information pieces are arranged in accordance with a work sequence order with which the unit work information pieces are executed.

According to the invention, it is possible to efficiently and easily execute setup change work in order to change over a product type.

### BRIEF DESCRIPTION OF THE DRAWINGS

FIG. 1 is an explanatory view of the configuration of a component mounting system according to an embodiment of the invention.

FIG. 2 is a plan view of a component mounting apparatus in the component mounting system according to the embodiment of the invention.

FIGS. 3A and 3B are explanatory views of the configuration of a component feeding portion and the configuration of a tape feeder in the component mounting apparatus according to the embodiment of the invention.

FIG. 4 is a block diagram showing the configuration of a control system of the component mounting system according to the embodiment of the invention.

FIG. 5 is an explanatory view of work instruction information used in instruction of setup change work in the component mounting system according to the embodiment of the invention.

FIG. 6 is a flow chart of work instruction processing of the setup change work in the component mounting system according to the embodiment of the invention.

### DETAILED DESCRIPTION OF THE EXEMPLARY EMBODIMENTS

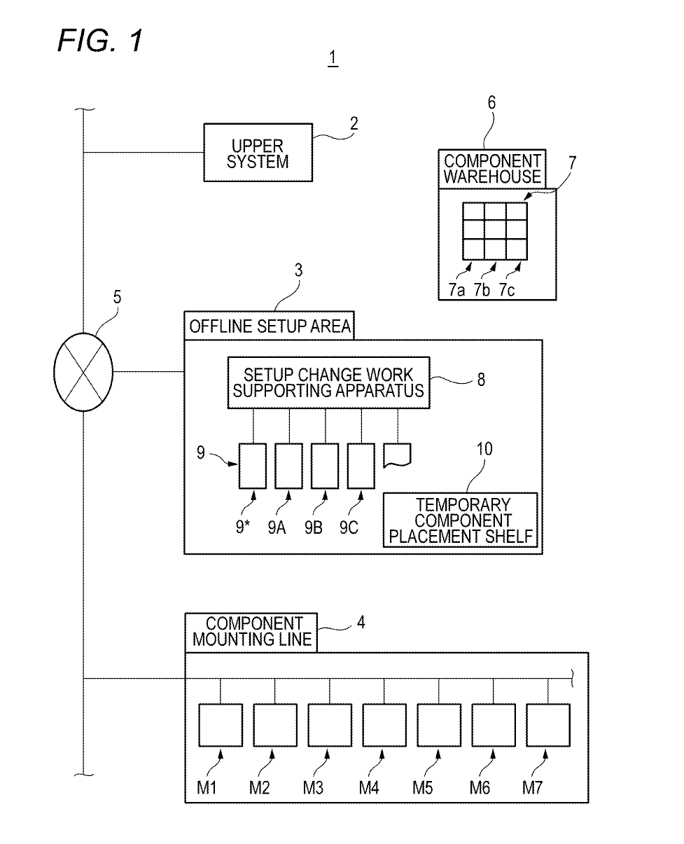

An embodiment of the invention will be described with reference to the drawings. First, the configuration of a component mounting system 1 will be described with reference to FIG. 1. The component mounting system 1 has a function of mounting components on substrates to produce mounted substrates. The component mounting system 1 mainly includes an upper system 2, an offline setup area 3, and a component mounting line 4. The sections are connected to one another through a network 5. The upper system 2 includes a management computer to manage production data or production schedules used in the component mounting system 1.

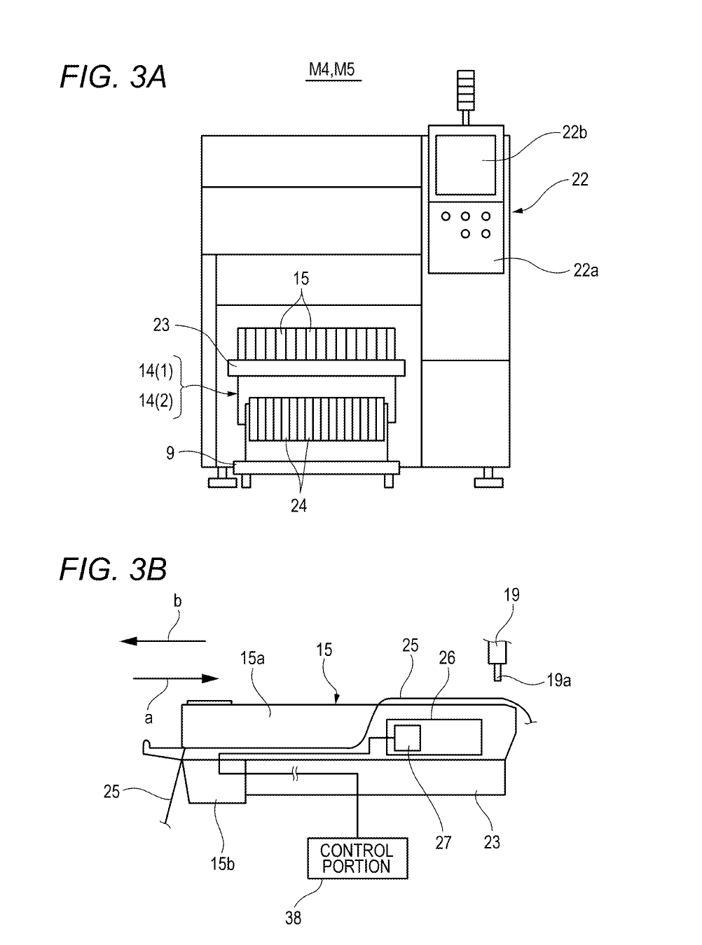

Further, the component mounting system 1 includes a component warehouse 6. A component placement shelf 7 for keeping feed reels 24 (see FIGS. 3A and 3B) from which components can be fed to be mounted on substrates, or tape feeders 15 in which the feed reels 24 are set is disposed in the component warehouse 6. The component placement shelf 7 is classified into a plurality of placement sections for storing the feed reels 24 or the tape feeders 15. The placement sections are given shelf identification codes (7a, 7b, 7c, . . . ) for specifying the respective placement sections individually.

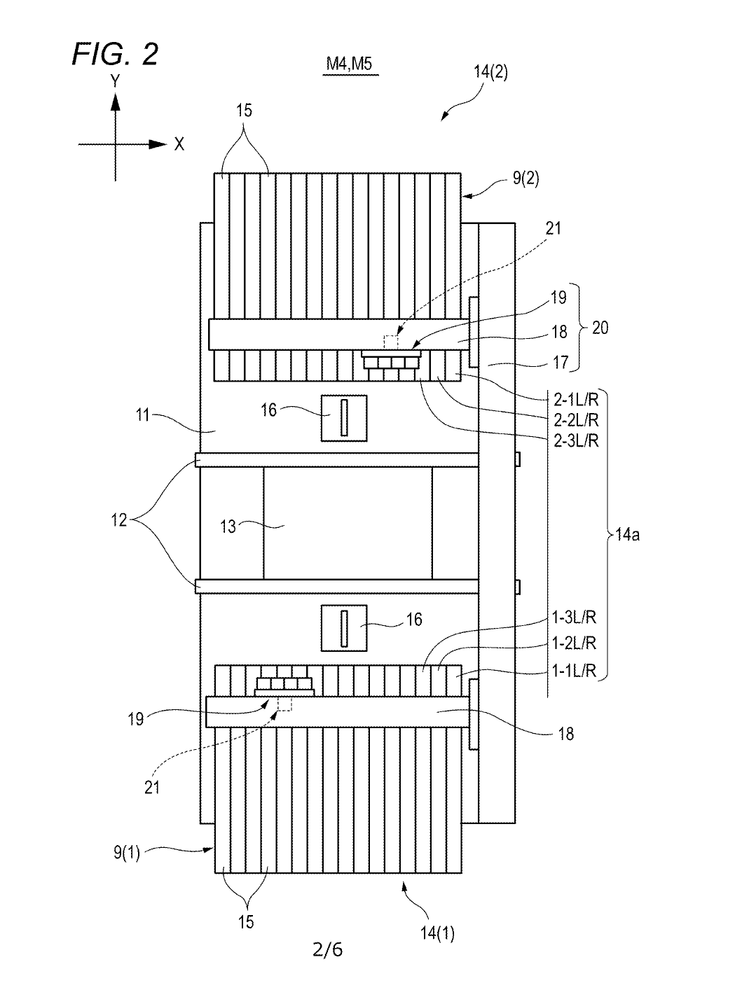

The component mounting line 4 includes a substrate supplying apparatus M1, a substrate delivering apparatus M2, a solder printing apparatus M3, component mounting apparatuses M4 and M5, a reflow apparatus M6, and a substrate collecting apparatus M7. The substrate supplying apparatus M1 to the substrate collecting apparatus M7 are connected to the upper system 2 through the network 5. Feed reels 24 taken out of the component warehouse 6 are conveyed to the offline setup area 3. Offline setup change work for setting feed reels 24 together with tape feeders 15 in carts 9 (see FIG. 2 and FIGS. 3A and 3B) in allocation states corresponding to a target product type is performed in the offline setup area 3. Incidentally, the carts 9 set as targets of the offline setup work in the offline setup area 3 will be described here as carts 9* so that the carts 9* can be distinguished from other spare carts 9 (carts 9A, 9B, . . . ) kept in the offline setup area 3.

The carts 9, which has been subjected to the offline setup work and in which the tape feeders 15 and the feed reels 24 have been set in the allocation states corresponding to the product type, are moved to the component mounting line 4 and attached to the component mounting apparatuses M4 and M5. In the component mounting line 4, components are mounted on bare substrates by the component mounting apparatuses M4 and M5. The bare substrates are supplied by the substrate supplying apparatus M1. Next, the substrates which have been mounted with the components are sent to the reflow apparatus M6 in which the mounted components are joined to the substrates by solder. The mounted substrates on which the components have been mounted by solder joining are collected by the substrate collecting apparatus M7.

The offline setup area 3 includes a setup change work supporting apparatus 8 for supporting the offline setup change work, and a temporary component placement shelf 10. Feed reels 24 and tape feeders 15 which have been removed from the component mounting apparatuses M4 and M5 and can be reused are temporarily placed on the temporary component placement shelf 10. The setup change work supporting apparatus 8 is a terminal machine such as a personal computer, having an arithmetic processing function, an input/output operation function and a display function. A worker who executes the offline setup change work executes the offline setup change work on the carts 9 in accordance with work instruction information displayed on a display screen of the setup change work supporting apparatus 8, before the carts 9 are moved to the component mounting line 4.

In an example shown here, a scheduled cart 9 by which a cart 9(1) illustrated in FIG. 2 will be replaced is assumed as a cart 9* as a work target of the offline setup change work. In the offline setup change work, movement or replacement of tape feeders 15 is performed on all the carts 9 existing on the production floor, including not only the spare carts 9 (carts 9A, 9B, . . . ) kept in the offline setup area 3 but also the carts 9 which have already been mounted in the component mounting apparatuses M4 and M5 of the component mounting line 4.

Next, the configuration and function of each of the component mounting apparatuses M4 and M5 performing component mounting work in the component mounting line 4 will be described below with reference to FIG. 2 and FIGS. 3A and 3B. In FIG. 2, a substrate conveyance mechanism 12 is disposed in an X direction on a pedestal 11. The substrate conveyance mechanism 12 uses a conveyor to convey a substrate 13 on which components will be mounted, and positions the substrate 13 in a mounting work position provided on the substrate conveyance mechanism 12.

A cart mounting portion 14(1) is provided in front of the substrate conveyance mechanism 12. A cart mounting portion 14(2) is provided at the rear of the substrate conveyance mechanism 12. Carts 9(1) and 9(2) serving as component feeding portions in which a plurality of parts feeders for feeding components have been set are mounted in the cart mounting portions 14(1) and 14(2) so that the carts 9(1) and 9(2) can be detachably attached to the component mounting apparatuses M4 and M5.

Feeder addresses 14a for specifying mounting positions of these parts feeders have been set on a feeder base 23 (see FIGS. 3A and 3B) provided in each of the carts 9(1) and 9(2). In the example illustrated in the embodiment, 1-1L/R, 1-2L/R, 1-3L/R . . . are set as the feeder addresses 14a in the cart 9(1) mounted in the cart mounting portion 14(1), in the named order from a downstream side (right side in FIG. 2) toward an upstream side. When these feeder addresses 14a are designated thus, the parts feeders mounted on the component mounting apparatus can be specified individually.

Similarly, 2-1L/R, 2-2L/R, 2-3L/R . . . are set as the feeder addresses 14a in the cart 9(2) mounted in the cart mounting portion 14(2), in the named order from the downstream side (right side in FIG. 2) toward the upstream side. Incidentally, any method for setting the sequence in the feeder addresses 14a may be used. The address sequence of each of the cart mounting portions 14(1) and 14(2) may be set reversely.

An example in which the tape feeders 15 each having a function of pitch feeding of a carrier tape holding components to be mounted have been mounted as the parts feeders is illustrated here. When the tape feeders 15 are driven, components are fed to component suction positions where the components can be sucked by suction nozzles 19a (see FIG. 3B) of a mounting head 19 which will be described as follows.

A Y-axis movement table 17 provided with a linear driving mechanism is disposed on one side end portion in the X direction in an upper surface of the pedestal 11. Two X-axis movement tables 18 each provided with a linear driving mechanism similarly are connected to the Y-axis movement table 17 so as to be moveable in the Y direction. A mounting head 19 is mounted on each of the two X-axis movement tables 18 to be moveable in the X direction. The mounting head 19 is a multiple head provided with a plurality of holding heads. A suction nozzle 19a which can suck and hold a component and lift up/down the component individually is mounted in a lower end portion of each of the holding heads.

The Y-axis movement table 17 and the X-axis movement tables 18 are driven to move the mounting heads 19 in the X direction and the Y direction. Thus, the two mounting heads 19 use the suction nozzles 19a to extract components from the component suction positions of the tape feeders 15 in the corresponding cart mounting portions 14(1) and 14(2), and transfer and mount the extracted components on mounting points of the substrate 13 positioned by the substrate conveyance mechanism 12. The Y-axis movement table 17, the X-axis movement table 18 and the mounting head 19 constitute a component mounting mechanism 20 in which the mounting head 19 having held components is moved to extract the components from the cart mounting portion 14(1), 14(2) and transfer and place the components on the substrate 13.

Component recognition cameras 16 are disposed between the cart mounting portions 14(1) and 14(2) and the substrate conveyance mechanism 12. When the mounting heads 19 which have extracted the components from the cart mounting portions 14(1) and 14(2) are moved above the component recognition cameras 16, the component recognition cameras 16 image and recognize the components held by the mounting heads 19. Substrate recognition cameras 21 which are positioned on lower surface sides of the X-axis movement tables 18 and move integrally with the mounting heads 19 are mounted on the mounting heads 19 respectively. When the mounting heads 19 move, the substrate recognition cameras 21 move above the substrate 13 which has been positioned by the substrate conveyance mechanism 12, and image and recognize the substrate 13. In a component mounting operation performed by the mounting heads 19 on the substrate 13, placement positions are corrected while results of the component recognition performed by the component recognition cameras 16 and results of the substrate recognition performed by the substrate recognition cameras 21 are taken into consideration.

FIG. 3A illustrates the component mounting portions 14(1) and 14(2) and an apparatus operating face in the component mounting apparatus M4, M5. Carts 9 in which a plurality of tape feeders 15 have been set in advance on the feeder bases 23 are mounted in the cart mounting portions 14(1) and 14(2). A plurality of feed reels 24 in which carrier tapes 25 having held components are accommodated in a wound state are retained in each of the carts 9. The carrier tapes 25 led out of the feed reels 24 are loaded onto the tape feeders 15 correspondingly.

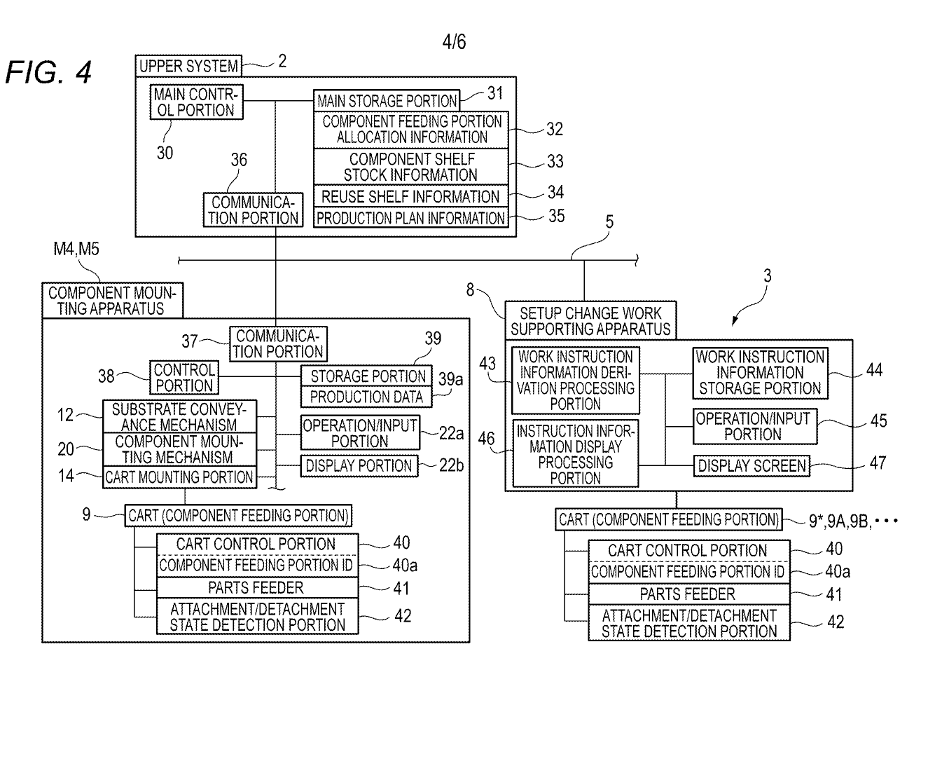

When the feeder bases 23 are clamped by clamping mechanisms (not illustrated), the positions of the carts 9 are fixed in the cart mounting portions 14(1) and 14(2). In addition thereto, the carts 9 are electrically connected to a control portion 38 (see FIG. 4) of the component mounting apparatus M4, M5. Thus, it is possible to detect that the carts 9 have been mounted in the component mounting apparatus M4, M5 and signals can be exchanged between the control portion 38 and cart control portions 40 (see FIG. 4) which will be described below. Component feeding portion IDs 40a (see FIG. 4) given in advance to the carts 9 respectively are stored in storage portions (not illustrated) of the cart control portions 40. When the respective carts 9 are mounted in the component mounting apparatus M4, M5, the control portion 38 can identify the carts 9 individually. Thus, by the identification function provided by the component mounting apparatus M4, M5, the respective carts 9 can be identified individually.

An operation portion 22 including a display portion 22b and an operation/input portion 22a is provided on the apparatus operating face. Operating buttons for performing various operation inputs are disposed in the operation/input portion 22a. The display portion 22b is a display device such as a liquid crystal panel. Various screens such as a guide screen for performing operation inputs through the operation/input portion 22a are displayed on the display portion 22b. Work instruction information used for instruction of setup change work required for changing over the product type is included in the screens.

The configuration and function of each tape feeder 15 will be described with reference to FIG. 3B. The tape feeder 15 includes a body portion 15a and a mounting portion 15b provided convexly downward from a lower surface of the body portion 15a. The lower surface of the body portion 15a is disposed along the feeder base 23. When the tape feeder 15 is slid in a direction of an arrow a, a so-called “attach” operation for attaching the tape feeder 15 to the feeder base 23 is performed. In addition, when the tape feeder 15 is slid in a direction of an arrow b in this state, a so-called “remove” operation for removing the tape feeder 15 from the feeder base 23 is performed.

In the state in which the feeder tapes 15 have been mounted, connector portions provided in the mounting portions 15b are fit into the feeder bases 23. Thus, the tape feeders 15 are fixedly mounted in the cart mounting portions 14(1) and 14(2) and the tape feeders 15 are electrically connected to the control portion 38 (see FIG. 4) of the component mounting apparatus M4, M5. Thus, it is possible to detect that the tape feeders 15 have been mounted on the feeder bases 23 of the component mounting apparatus M4, M5 and it is possible to exchange signals between the control portion 38 and feeder control portions 27 which will be described below.

Tape feeding portions 26 including tape feeding mechanisms for pitch-feeding of the carrier tapes 25 are built in the body portions 15a. Each of the tape feeding portions 26 includes a driving mechanism and a feeder control portion 27. The driving mechanism drives and rotates a tape feeding sprocket provided in a distal end portion of a tape travelling path. The feeder control portion 27 controls the driving mechanism. The tape feeding portions 26 perform pitch-feeding of the carrier tapes 25 led out of the feed reels 24, so that the carrier tapes 25 can reach pickup positions where the suction nozzles 19a of the mounting heads 19 can pick up components. Feeder ID codes with which the tape feeders 15 can be identified and specified from other tape feeders 15 are stored in storage devices built in the feeder control portions 27. When the tape feeders 15 are mounted on the carts 9, the control portion 38 can identify the respective tape feeders 15 individually.

That is, the component mounting system 1 shown in the embodiment includes cart identification units and feeder identification units. The cart identification units identify the carts 9 mounted in the cart mounting portions 14(1) and 14(2) individually. The feeder identification units identify the tape feeders 15 set in the carts 9 individually. In the embodiment, based on identification results of the feeder identification units, it is determined whether a work result of the setup change work executed by the worker is successful or not. Incidentally, the configuration of each cart identification unit and the configuration of each feeder identification unit are not limited particularly. Configuration may be used such that cart identification information and reel identification information such as barcodes or IC tags provided in the carts 9 and the feed reels 24 can be read automatically or manually by the worker who operates a reader terminal machine.

Next, the configuration of the control system will be described with reference to FIG. 4. The upper system 2 includes a main control portion 30 and a main storage portion 31. The main control portion 30 has a function as a management computer. The upper system 2 exchanges control signals or information with the respective apparatuses constituting the component mounting system 1 through a communication portion 36 and the network 5. Component feeding portion allocation information 32, component shelf stock information 33, reuse shelf information 34, and production plan information 35 are stored in the main storage portion 31.

The component feeding portion allocation information 32 is information about allocation states of parts feeders 41 such as tape feeders 15 in all the carts 9 existing in the production area, including the carts 9 which are currently attached to the component mounting apparatuses M4 and M5 of the component mounting line 4, the spare carts 9 which are allocated in the offline setup area 3, etc. The component shelf stock information 33 is stock information in which feed reels 24 kept in stock in the respective placement sections of the component placement shelf 7 disposed in the component warehouse 6 are associated with shelf identification codes (7a, 7b, 7c . . . ) for specifying the respective placement sections individually. The reuse shelf information 34 is data for specifying tape feeders 15 and feed reels 24 which are temporarily placed on the temporary component placement shelf 10 of the offline setup area 3 so as to be reused. The production plan information 35 is data indicating production times and production quantities of substrates to be produced by the component mounting line 4, in accordance with product types expressing substrate types.

The component mounting apparatus M4, M5 is connected to the network 5 through a communication portion 37. The component mounting apparatus M4, M5 includes a control portion 38 and a storage portion 39. The control portion 38 is an arithmetic processing device which controls the substrate conveyance mechanism 12, the component mounting mechanism 20 and the carts 9 mounted in the cart mounting portions 14, based on data such as production data 39a stored in the storage portion 39, i.e. mounting data downloaded from the main storage portion 31 of the upper system 2 and stored in accordance with the product types to be produced, and the component feeding portion allocation information 32. Thus, component mounting work for mounting components extracted from the respective tape feeders 15 on a substrate 13 can be executed.

The component feeding portion IDs 40a are given individually to the carts 9. The component feeding portion IDs 40a of the carts 9 mounted in the cart mounting portions 14 are read by reading units provided in the cart mounting portions 14. The control portion 38 identifies results of the reading, so that the mounted carts 9 can be identified. The tape feeders 15 as the parts feeders 41 are mounted on the carts 9. In this state, attachment/detachment state detection portions 42 detect feeder IDs given individually to the mounted tape feeders 15.

The control portion 38 identifies the detected feeders IDs in the same manner so that the mounted tape feeders 15 can be identified. Identification results of the carts 9 or the tape feeders 15 to be identified are compared with the data defined in advance in the production data 39a, so that it is possible to check whether or not the tape feeders 15 which are attached to the feeder addresses 14a of the carts 9 are correct tape feeders 15 which should be originally attached to the feeder addresses 14a. The operation/input portion 22a and the display portion 22b are provided in the operation portion 22 on the apparatus operating face illustrated in FIG. 3A, so as to input necessary operation/data during an operating time or display various operation/guide screens.

The setup change work supporting apparatus 8 has a function of providing various information or various display screens to be referred to for efficiently and easily performing setup change work such as replacement or allocation change of tape feeders 15. The setup change work is required in the carts 9(1) and 9(2) mounted in the mount mounting portions 14(1) and 14(2) in order to change over the product type. An example in which the setup change work is executed in advance in the offline setup area 3 before the carts 9(1) and 9(2) are conveyed to the component mounting line 4 is shown in the embodiment.

The setup change work supporting apparatus 8 includes a work instruction information derivation processing portion 43, a work instruction information storage portion 44, an operation/input portion 45, an instruction information display processing portion 46 and a display screen 47. As to each cart 9* on which the work will be performed in the offline setup area 3, current feeder allocation information corresponding to allocation states of currently allocated tape feeders 15, and first feeder allocation information corresponding to first allocation states of tape feeders 15 for a product type (first product type) to be produced next are included in the component feeding portion allocation information 32 stored in the main storage portion 31 of the upper system 2. Based on the current feeder allocation information and the first feeder allocation information, the work instruction information derivation processing portion 43 derives work instruction information which defines required setup change work so that the allocation states of the tape feeders 15 in each cart 9* serving as a work target can be changed over from allocation states where the setup change work has not been started yet to the first allocation states corresponding to the first product type.

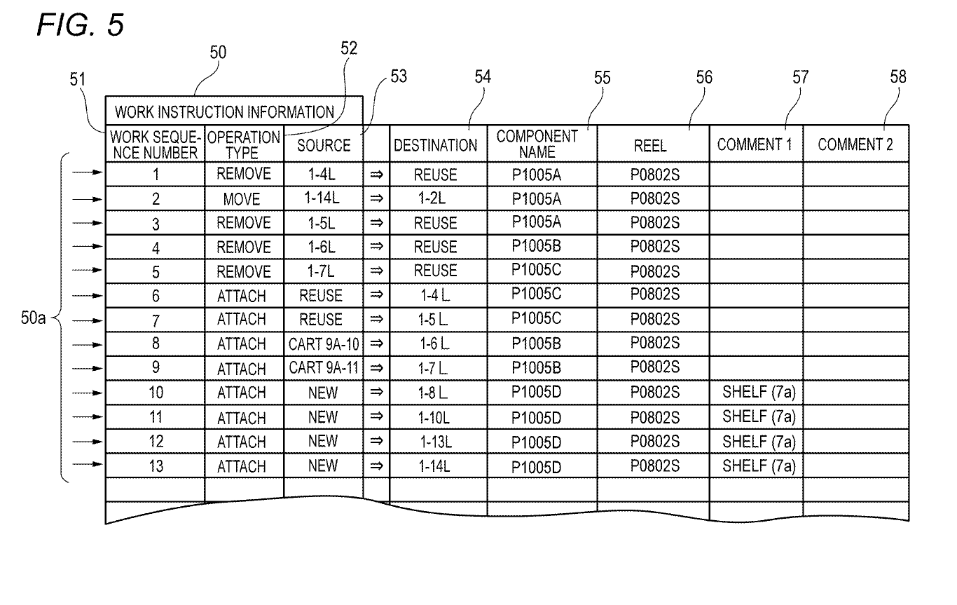

The derived work instruction information is stored in the work instruction information storage portion 44. The instruction information display processing portion 46 performs a process to read the work instruction information from the work instruction information storage portion 44 and a process to display the read work instruction information on the display screen 47 in accordance with a predetermined display format. The processes are executed by the worker who performs operation inputs through the operation/input portion 45. Thus, work instruction information 50 illustrated in FIG. 5 is displayed on the display screen 47 and the worker executes the setup change work sequentially in accordance with the display contents of the work instruction information 50.

Incidentally, an example in which a single apparatus such as a personal computer, having an independent arithmetic processing function and a storage device is used as the setup change work supporting apparatus 8 has been shown here, the specific embodiment of the invention is not limited to such a configuration but may include various variations. For example, the function of the setup change work supporting apparatus 8 may be contained in the upper system 2 or the individual component mounting apparatuses M4 and M5. In this case, display portions provided in the respective apparatuses may be used as the display screen 47.

The data configuration of the work instruction information 50 will be described with reference to FIG. 5. In FIG. 5, the work instruction information 50 is prepared whenever setup change work is performed in order to change over the product type to be produced. The work instruction information 50 includes unit work information pieces 50a which define contents of works the worker should execute on individual tape feeders 15 as work targets. The unit work information pieces 50a are displayed in the order of “work sequence numbers” 51 in accordance with which the works should be executed. That is, each unit work information piece 50a includes various items of “work sequence number” 51, “operation type” 52, “source” 53, “destination” 54, “component name” 55, “reel” 56, “comment 1” 57, and “comment 2” 58.

The “operation type” 52 is type information indicating a type of an execution operation to be performed in the unit work information piece 50a in the setup change work. In the embodiment, “remove”, “attach” and “move” are defined as operation information. “Remove” indicates an execution operation to remove a tape feeder 15 which has already been allocated in a cart 9* (see the arrow b illustrated in FIG. 3B). “Attach” indicates an execution operation to newly allocate a tape feeder 15 in a cart 9* (see the arrow a illustrated in FIG. 3B). “Move” indicates an execution operation to once remove a tape feeder 15 from a cart 9* and then relocate the tape feeder 15 directly to another feeder address 14a of the cart 9*.

In the example illustrated in FIG. 5, the unit work information pieces 50a whose “work sequence numbers” 51 are 1, 3, 4 and 5 have “remove” as their execution operation, and the unit work information piece 50a whose “work sequence number” 51 is 2 has “move” as its execution operation. After these unit work information pieces 50a having “remove” as their execution operation have been completed, the unit work information pieces 50a having “attach” as their execution operation are defined in the “work sequence numbers” 51 which are 6 and higher. Thus, the reason why the unit work information pieces 50a always including “remove” as their execution operation are first displayed in preceding orders is to give a clear instruction of a reasonable work procedure to the worker so as to prevent the worker from confusing the work procedure due to mistake or misidentification.

That is, in the embodiment, the type information defining the “operation types” 52 includes at least “remove” and “attach”. “Remove” indicates an execution operation to remove a tape feeder 15 which has already been allocated in a cart 9*, and “attach” indicates an execution operation to newly allocate a tape feeder 15 in a cart 9*. The work instruction information derivation processing portion 43 is designed so that the unit work information pieces 50a sorted in accordance with the “operation types” 52 can be displayed in the display order in which “attach” is arranged following “remove”.

The “source” 53 indicates an allocation state in which the setup change work on a tape feeder 15 as a work target in the setup change work has not been started yet. On the other hand, the “destination” 54 indicates an allocation state in which the setup change work has been executed, that is, the allocation state has been changed into a first allocation state corresponding to a first product type. For example, the unit work information piece 50a whose “work sequence number” 51 is 1 indicates that “remove” from a cart 9* should be executed on a tape feeder 15 which is currently allocated at a feeder address 14a of 1-4L while a feed reel 24 and a carrier tape 25 should not be removed from the tape feeder 15 but the tape feeder 15 kept integrally with the feed reel 24 should be temporarily placed on the temporary component placement shelf 10 of the offline setup area 3 in order to be reused in and after next production.

The worker who has executed the temporary placement of the tape feeder 15 inputs the state of the tape feeder 15 through the operation/input portion 45 of the setup change work supporting apparatus 8. Thus, the state in which the tape feeder 15 is temporarily placed integrally with the feed reel 24 is stored as reuse shelf information 34 in the main storage portion 31. Similarly, the unit work information pieces 50a whose “work sequence numbers” 51 are 3, 4, and 5 indicate that “remove” from the cart 9* should be executed on tape feeders 15 which are currently allocated at feeder addresses 14a of 1-5L, 1-6L and 1-7L, and the tape feeders 15 should be temporarily placed integrally with the feed reels 24 on the temporary component placement shelf 10 of the offline setup area 3 to be kept temporarily so that the tape feeders 15 provided integrally with the feed reels 24 can be reused.

In addition, the unit work information piece 50a whose “work sequence number” 51 is 2 indicates that the tape feeder 15 which is currently mounted at a feeder address 14a of 1-14L should be once removed and “move” should be executed to remount the tape feeder 15 at a feeder address 14a of 1-2L for next production. Each of the unit work information pieces 50a whose “work sequence numbers” 51 are 6 and higher has “attach” as its “operation type” 52 by way of example.

Here, in the unit work information pieces 50a whose “work sequence numbers” 51 are 6 and 7, both the “sources” 53 are reuse and feeder addresses 14a of 1-4L and 1-5L are designated as the “destinations” 54 respectively. That is, the tape feeders 15 which have been temporarily placed integrally with feed reels 24 on the temporary component placement shelf 10 of the offline setup area 3 are attached to the feeder addresses 14a of 1-4L and 1-5L which are empty because “remove” has already been executed thereon.

In addition, in the unit work information pieces 50a whose “work sequence numbers” 51 are 8 and 9, the “sources” 53 are Cart 9A-10 and Cart 9A-11 respectively and feeder addresses 14a of 1-6L and 1-7L are designated as the “destinations” 54. That is, tape feeders 15 which have been attached to feeder addresses 14a of 10 and 11 in a spare cart 9A which is kept in the offline setup area 3 are attached to the feeder addresses 14a of 1-6L and 1-7L which are empty because “remove” has been already executed thereon.

In the unit work information pieces 50a whose “work sequence numbers” 51 are 10 and higher, all the “sources” 53 are “new”. In this case, feed reels 24 kept in the component warehouse 6 or tape feeders 15 provided integrally with the feed reels 24 are newly taken out and newly attached and allocated to feeder addresses 14a defined in the “destinations” 54.

The “component name” 55 appended to each unit work information piece 50a designates the component name of a component fed by the tape feeder 15. The “reel” 56 indicates a type of a feed reel used in the tape feeder 15. Various instruction information auxiliarily required in the setup change work may be designated in the “comment 1” 57 or the “comment 2” 58. For example, in the case where a shelf identification code (7a, 7b, 7c, . . . ) designating a placement section of the component warehouse 6 is designated in the “source” 53 and “reuse” is designated in the “destination” 54, a shelf number etc. for specifying a location of the temporary component shelf 10 where the removed tape feeder 15 is temporarily kept may be displayed in the “comment 1” 57 or the “comment 2” 58.

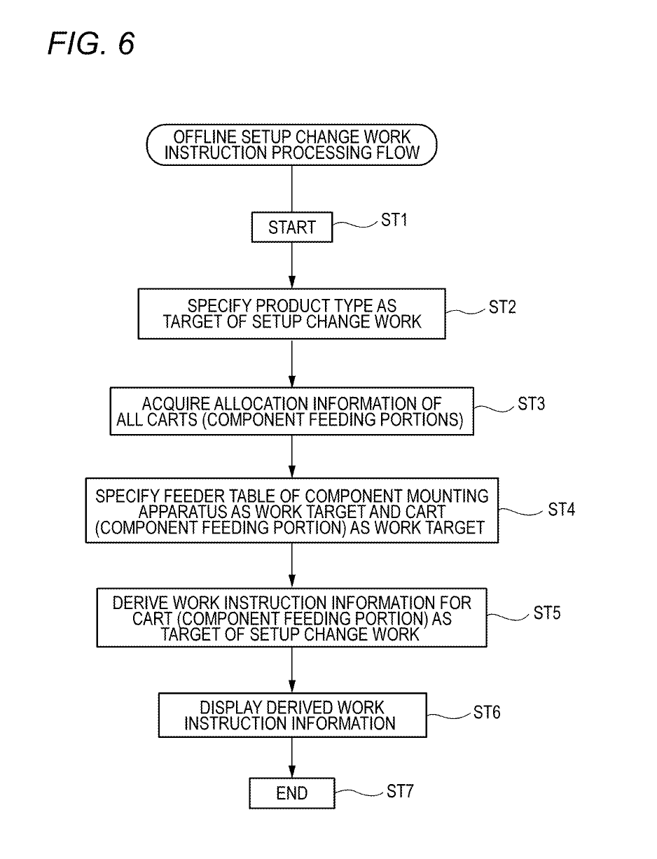

Next, a setup change work instruction method for instructing setup change work which needs to be performed in order to change over a product type in the component mounting system 1 having the aforementioned configuration will be described in accordance with a processing flow of FIG. 6. First, when setup change work is started (ST1), a product type as a setup change target is first specified (ST2). That is, a product type as a target to be produced next is specified with reference to the production plan information 35 stored in the main storage portion 31 of the upper system 2. Here, a first product type is specified as the target to be produced next.

Next, allocation information of all carts 9 (component feeding portions) is acquired (ST3). That is, information about allocation states of tape feeders 15 in carts 9(1) and 9(2) which are currently attached to the component mounting apparatuses M4 and M5, and information about allocation states of tape feeders 15 in carts 9*, 9A and 9B which have been removed from the component mounting apparatuses M4 and M5 and exist in the offline setup area 3 are acquired (component feeding portion information acquiring step).

Next, a feeder table of one component mounting apparatus as a work target and a cart 9 (component feeding portion) as a work target are specified (ST4). Here, a cart mounting portion 14(1) of one of the component mounting apparatuses M4 and M5 is the feeder table of the work target, and of the plurality of carts 9 which are kept in the offline setup area 3, a cart 9* which has been designated in advance is specified as the work target.

Next, processing (ST5) for deriving work instruction information for the cart 9* (component feeding portion) as a target of the setup change work is executed by the work instruction information derivation processing portion 43. That is, work instruction information 50 (see FIG. 5) is derived (work instruction information deriving step). The work instruction information 50 defines required setup change work so that allocation states of tape feeders 15 in the cart 9* as the target of the setup change work can be changed from allocation states in which the setup change work has not been started yet to first allocation states corresponding to a first product type. Thus, the allocation states of the tape feeders 15 can be adapted to an event in which the product type will be changed over to the first product type. The derived work instruction information is stored in the work instruction information storage portion 44. Next, the work instruction information 50 illustrated in FIG. 5 is displayed on the display screen 47 by the instruction information display processing portion 46 (instruction information displaying step) (ST6). Thus, setup change processing applied to one cart 9* is completed (ST7).

Here, the work instruction information 50 has a configuration including a plurality of unit work information pieces 50a each containing a combination of an “operation type” 52, a “source” 53 and a “destination” 54. The “operation type” 52 is type information indicating a type of an execution operation in the setup change work. The “source” 53 and the “destination” 54 are feeder state information indicating a state in which the work on a tape feeder 15 as a work target in the setup change work has not been executed yet and a state in which the work on the tape feeder 15 has been executed, respectively. In the embodiment, the aforementioned state in which the work has not been executed yet may include the state in which the tape feeder 15 has been allocated in a cart 9 which has not been attached to each of the component mounting apparatuses M4 and M5 yet.

That is, all of the carts 9 which are currently attached to the component mounting apparatuses M4 and M5 and the carts 9 which are kept in the offline setup area 3 are included as the “sources” 53 before the work is executed. Thus, a selection range of the “sources” 53 from each of which a tape feeder 15 required for setup change needs to removed can be expanded so that efficiency of the setup change work can be improved. In the instruction information displaying step, the plurality of unit work information pieces 50a generated thus are displayed on the display screen 47 so that the unit work information pieces 50a can be arranged in a work sequence order with which the unit work information pieces 50a should be executed.

In addition, “remove” and “attach” are included in the “operation types” 52. “Remove” serves as first information indicating an execution operation to remove a tape feeder 15 which has already been allocated in a cart 9 serving as a component feeding portion. “Attach” serves as second information indicating an execution operation to newly allocate a tape feeder 15 in a cart 9. In the instruction information displaying step, the unit work information pieces 50a sorted in accordance with the pieces of the type information are displayed in a display order in which the operation type “attach” is arranged following the operation type “remove”. That is, the unit work information pieces 50a including the second work information are displayed following the unit work information pieces 50a including the first information.

As described above, the component mounting apparatus M4, M5 of the component mounting line 4 includes a feeder identification unit which identifies tape feeders 15 allocated in the cart 9(1), 9(2) serving as a component feeding portion mounted in the cart mounting portion 14(1), 14(2). In the embodiment, by use of this function, the feeder identification unit identifying the tape feeders 15 allocated in the cart 9 can detect a situation in which a work result of the setup change work executed by the worker is different from the displayed work instruction information 50. Then, unit work information pieces 50a required for correcting the work result to a correct one based on the work instruction information 50 can be derived newly and additionally displayed on the display screen 47.

Incidentally, the display form of the work instruction information 50 in the execution process of the setup change work may include various variations. For example, in the work execution process in the offline setup area 3, attachment/removal detection and identification of the tape feeders 15 at the feeder addresses 14a of the cart 9* can be executed in real time by a control/detection function provided by the setup work supporting apparatus 8. The attachment/removal detection and identification results may be displayed in real time on the work instruction information 50 displayed on the display screen 47. For example, unit work information pieces 50a which have been executed may be displayed by hatching or with checkmarks so that the unit work information pieces 50a which have been executed can be distinguished from other unit work information pieces 50a. Thus, the worker can easily judge which unit work information pieces 50a have been executed and which unit work information pieces 50a have not been executed.

In the embodiment, the “sources” 53 including the carts 9 attached to the component mounting apparatuses M4 and M5 of the component mounting line 4 are selected. Accordingly, there is a fear that a mistake may be made to select, as targets to be moved, tape feeders 15 which are in use in the component mounting work for the current product type. To prevent such a mistake, tape feeders 15 which are currently in use or which are scheduled to be used for the current product type are displayed, for example, by hatching or with checkmarks. In such a display manner, the fact that the tape feeders 15 are currently in use or scheduled to be used for the current product type can be displayed. These unit work information pieces 50a of the tape feeders 15 can be set as targets of the setup change work after the use of the tape feeders 15 for the current product type has been completed.

As described above, in an instruction of setup change work in the component mounting system shown in the embodiment, information about allocation states of tape feeders 15 in carts 9 which are currently attached to the component mounting apparatuses M4 and M5, and information about allocation states of tape feeders 15 in carts 9 which have been removed from the component mounting apparatuses M4 and M5 are acquired. Then, work instruction information is derived. The work instruction information defines required setup change work so that allocation states of tape feeders 15 in a cart 9 as a target of the setup change work can be changed from allocation states where the setup change work has not been started yet to first allocation states corresponding to a first product type. Thus, the allocation states of the tape feeders 15 can be adapted to the event in which the product type will be changed over to the first product type. The derived work instruction information is displayed on the display screen. In displaying the instruction information, a plurality of unit work information pieces are displayed on the display screen so that the unit work information pieces can be arranged in the work sequence order with which the unit work information pieces should be executed.

Thus, the invention can efficiently and easily perform the setup change work in order to change over the product type. The invention has a particularly conspicuous effect when it is applied to offline setup work. Although an example in which a cart 9 kept in the offline setup area 3 is used as a cart 9* as a work target of the setup change work has been described in the embodiment, the invention can be also applied to the case where a cart 9 attached to one of the component mounting apparatuses M4 and M5 of the component mounting line 4 is used as a work target of the setup change work. Also in this case, the selection range of the “sources” 53 from each of which a tape feeder 15 required for the setup change needs to be removed can be expanded in the same manner as in the case where the cart 9 kept in the offline setup area 3 is used as the work target. Thus, efficiency of the setup change work can be improved.

The setup change work instruction method according to the invention has an effect that setup change work for changing over a product type can be performed efficiently and easily. The setup change work instruction method according to the invention can be applied to a field in which mounted substrates in which electronic components are mounted on substrates are manufactured.

What is claimed is:

1. A setup change work instruction method for giving an instruction to a worker to perform setup change work on a component mounting apparatus in order to change over a product type, the component mounting apparatus comprising a component feeding portion which can be attached to or detached from the component mounting apparatus and in which a plurality of parts feeders can be allocated, the method comprising:
acquiring information about allocation states of the parts feeders in the component feeding portion which is currently attached to the component mounting apparatus and information about allocation states of the parts feeders in a component feeding portion which has been detached from the component mounting apparatus;
deriving work instruction information which defines required setup change work so that allocation states of parts feeders in one of the component feeding portions as a target of the setup change work are changed over from allocation states in which the setup change work has not been started yet to first allocation states corresponding to a first product type in order to be adapted to an event in which the product type is changed over to the first product type; and
displaying the derived work instruction information on a display screen;
wherein the work instruction information includes a plurality of unit work information pieces, and the plurality of unit work information pieces are displayed on the display screen in the displaying step so that the unit work information pieces are arranged in accordance with a work sequence order with which the unit work information pieces are executed.

2. The setup change work instruction method according to claim 1, wherein each of the unit work information pieces includes type information and feeder state information, the type information indicating a type of an execution operation in the setup change work, the feeder state information indicating a state in which the work on a parts feeder serving as a work target in the setup change work has not been executed and a state in which the work on the parts feeder has been executed; and
wherein the state in which the work has not been executed includes a state in which the parts feeder is allocated in the component feeding portion which has not been attached to the component mounting apparatus.

3. The setup change work instruction method according to claim 1, wherein the type information includes at least first information and second information, the first information indicating an execution operation to remove a parts feeder which has already been allocated in the component feeding component, the second information indicating an execution operation to newly allocate a parts feeder in the component feeding portion; and
wherein the unit work information piece including the second information is arranged and displayed following the unit work information piece including the first information in the displaying step.

4. The setup change work instruction method according to claim 1, wherein a situation in which a work result of the setup change work which has been executed by the worker is different from the displayed work instruction information is detected by identifying the parts feeders allocated in the component feeding portion, and any unit work information piece required for correcting the work result to a correct one based on the work instruction information is newly derived and additionally displayed on the display screen.
